(19) United States
(12) Patent Application Publication
(10) Pub. No.: US 2009/0133204 A1
(43) Pub. Date: May 28, 2009

(54) REMOTE CONTROLLED SWEEP AND WIPE MACHINE

(76) Inventor: Wan-Jia Lin, Miaoli County (TW)

Correspondence Address: APEX JURIS, PLLC, 12733 LAKE CITY WAY NORTHEAST, SEATTLE, WA, 98125, US

(21) Appl. No.: 11/944,988

(22) Filed: Nov. 26, 2007

(51) Int. Cl. A47L 11/24; A46B 15/00; B60L 9/00; B62D 1/28

(52) U.S. Cl. 15/21.1; 15/256.5; 180/167; 180/2.1

(57) ABSTRACT

A remote controlled sweep and wipe machine includes an upper housing and a carrying base which are removably assembled together to form an inner space for accommodating a battery, a remote control receiver and an electronic control device, two tires mounted at two sides of the rear end of the carrying base, a sweeping brush mounted in the inner space to contact with the floor, a dust collecting box for receiving the dust swept by the sweeping brush, a cleaning cloth set pivotally mounted on a rear rack at the rear end of the carrying base to contact with the floor and to wipe the floor, a universal wheel mounted under the carrying base at the front end thereof so as to direct the sweep and wipe machine, and a remote controller.

### FIELD OF THE INVENTION

The present invention is related to a remote controlled sweep and wipe machine, and more particularly, to a sweep and wipe machine which can be remotely controlled to clean and wipe the floor directionally.

### BACKGROUND OF THE INVENTION

The most convenient tool for cleaning trash is broom, but obviously, it is only suitable for a small range of floor and is very inefficient for cleaning a large range of floor. Therefore, for labor-saving, an electric sweeper is already developed which can be controlled to automatically sweep and collect the trash on the way passed thereby.

However, no matter the traditional broom or the electric sweeper, both have to be driven and moved by the user, so that it is very inconvenient for the user who can not move well. Even for a normal user, it still might cause the user to have a sore waist and an aching back as operation, especially in the regions with more barriers or under the furniture (such as chair or table). Besides, owing to the limitation of the structure and volume of the broom and the electric sweeper, it is also hard to go deep thereinto for cleaning.

In addition, after cleaning by the broom or the electric sweeper, if the user wants to have a cleaner floor, he or she has to wipe the floor by mop or wiper for removing the tiny dust that can not be swept or to wax the floor by cloth. However, it is known that the wiping and waxing jobs actually are more tired and may waste more physical strength, so that the waist and the back of the user will more easily feel the pain.

### SUMMARY OF THE INVENTION

Therefore, the object of the present invention is to provide a sweep and wipe machine which can be remotely controlled to clean and collect trash automatically, so that it can be labor-saving, convenient and easy to operate and more suitable for the user who cannot move well.

Another object of the present invention is to provide a sweep and wipe machine which has a cleaning cloth mounted thereon for wiping the floor after sweeping, so as to remove the tiny dusts which can not be swept and also provide the function of waxing.

The present invention is related to a remote controlled sweep and wipe machine, including an upper housing and a carrying base which are removably assembled together to form an inner space, a battery mounted in the inner space, a remote control receiver mounted in the inner space, two tires mounted at two sides of the rear end of the carrying base to contact with the floor and controlled by a motor change gear set to turn, a sweeping brush mounted in the inner space under a sweeping brush cover to contact with the floor and controlled by a first motor transmission set to have a pivot turn, a dust collecting box, removably located in the inner space, adjacent to the sweeping brush and having a dust collecting opening at a surface opposite to the sweeping brush or receiving the dust swept by the sweeping brush, a rear rack mounted at the rear end of the carrying base through plural pivoting elements, and having a cleaning cloth set pivotally mounted thereon to contact with the floor, wherein the cleaning cloth set is controlled by a second motor transmission set so as to have a pivot turn, a universal wheel mounted under the carrying base at the front end thereof, and controlled by a steering motor set to rotate, an electronic control device electrically connected with the battery, the motor change gear set, the first motor transmission set, the second motor transmission set, the steering motor set and the remote control receiver, and a remote controller for wirelessly transmitting a direction control signal to the remote control receiver, so as to control the moving direction of the sweep and wipe machine.

The present invention is advantageous that the sweep and wipe machine can be remotely controlled to move and automatically sweep and collect the trash and dust, and to wipe the floor after cleaning for removing the tiny dust and waxing the floor, so that the operation is labor-saving, convenient and easy, and thus, it is very suitable for the user who can not move well. Moreover, in the area that has more barriers or is under the furniture, the sweep and wipe machine according to the present invention can have a free movement and can go deep thereinto for cleaning. Besides, the user also can exchange the sweeping brush and the cleaning cloth set for more proper ones in accordance with different demands.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a three-dimensional view showing the appearance of the present invention;

FIG. 2 is a three-dimensional drawing showing the decomposition of the present invention; and

FIG. 3 is a back view showing the appearance of the present invention.

### DESCRIPTION OF THE PREFERRED EMBODIMENT

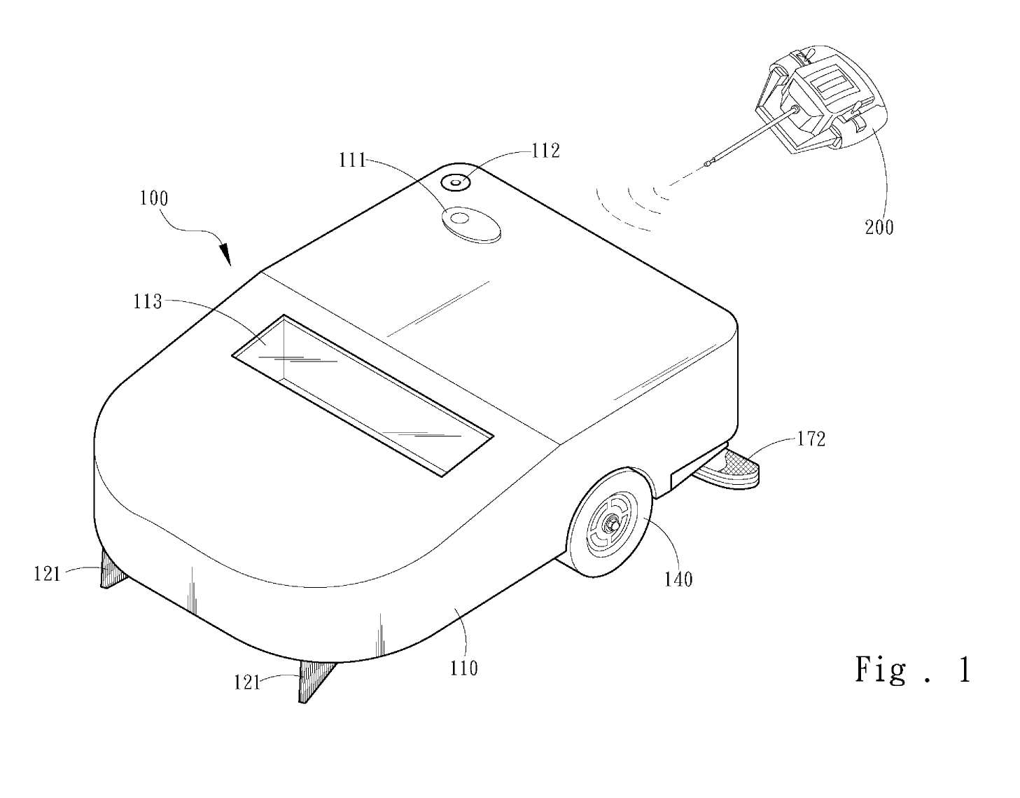

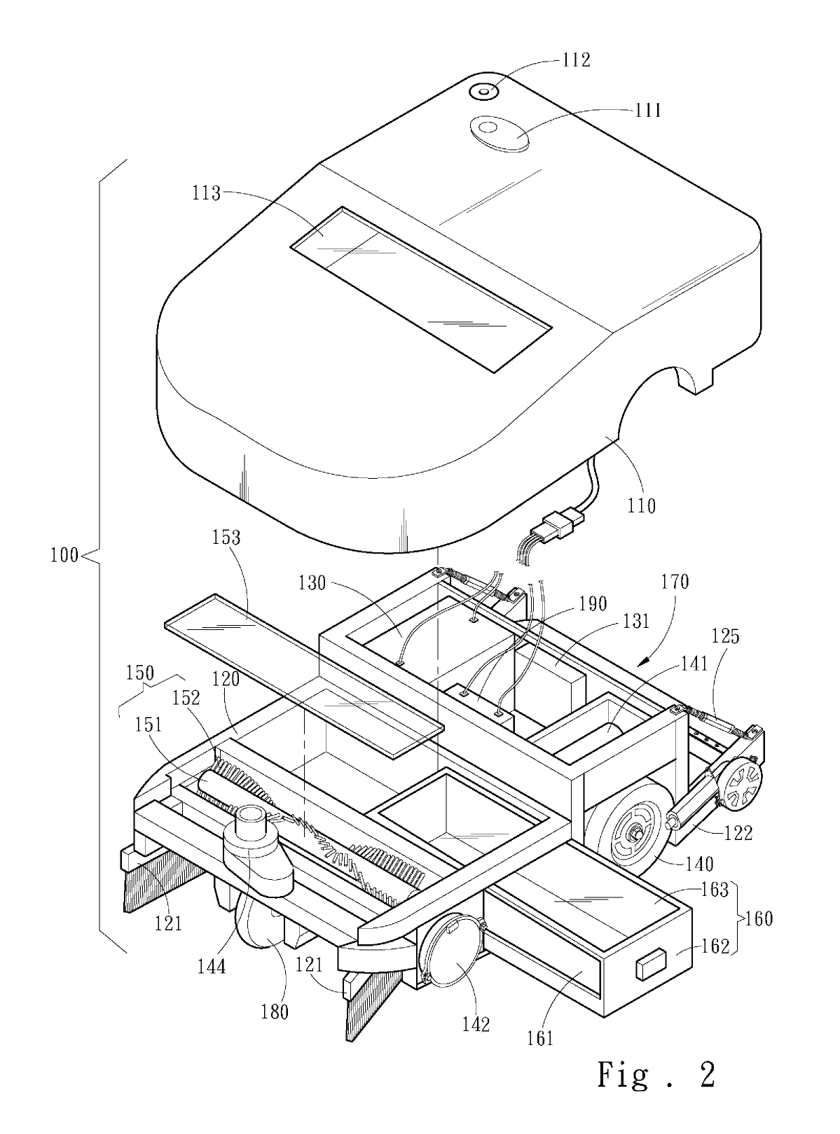

Please refer FIG. 1 and FIG. 2, which respectively show the appearance and the decomposition of a remote-controlled sweep and wipe machine according to the present invention. The sweep and wipe machine 100 includes an upper housing 110 and a carrying base 120 which are assembled together to form an inner space, and two tires 140 mounted at two sides of the rear ends of the carrying base 120 for contacting the floor, wherein the tires 140 are controlled and rotated by a motor change gear set 141, so that the sweep and wipe machine 100 can move forward and backward.

The upper housing 110 of the sweep and wipe machine 100 further includes an external power source plugging hole 112 for charging a battery 130 inside the sweep and wipe machine 100, and a power button 111 electrically connected with an electronic control device 190 for initiating the sweep and wipe machine 100.

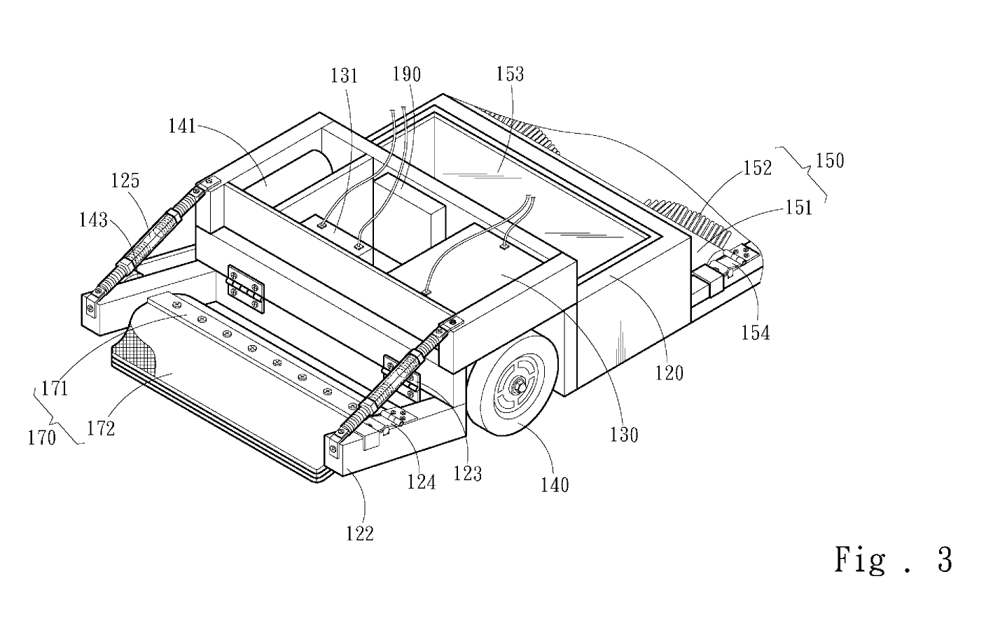

If the upper housing 110 is removed, it can be seen that a planned accommodating space is located on the carrying base 120. In the accommodating space, the battery 130, a remote control receiver 131, an electronic control device 190 and a sweeping brush 150 mounted in the inner space are included, wherein the sweeping brush 150 is pivotally mounted under a sweeping brush cover 153, which is located in the inner space, and is contacted with the floor, and the sweeping brush is controlled by a first motor transmission set 142 so as to have a pivot turn. The sweeping brush 150 includes a brush main body 151 that is pivoted on the carrying base 120, wherein one end of the brush main body 151 is connected to the first motor transmission set 142 and the other end is removably pivoted to the carrying base 120 through an engaging device 154 (as shown in FIG. 3), so that the user can change the sweeping brush 150 by himself or herself for a more proper one according to different demands. The brush main body 151 has plural brush hairs 152 mounted thereon, and when the sweeping brush 150 is driven by the first motor transmission set 142 to rotate, the brush hairs 152 can clean the floor. Furthermore, through the sweeping brush cover 153, a backward airflow around the sweeping brush 150 can be formed when the sweeping brush 152 is pivotally turned, so that the dust and trash can be drawn into a dust collecting box 160. Besides, on the carrying base 120, two side brushes 121 are respectively mounted at the two ends of the sweeping brush 150, for not only sweeping the side dust and trash to the sweeping range of the sweeping brush 150 but also properly increasing the cleaning area of the sweep and wipe machine 100.

The dust collecting box 160 is composed of a box body 162 and a box cover 163 and can be drawn out from the inner space. The dust collecting box 160 is adjacent to the sweeping brush 150 and has a dust collecting opening 161 located at a surface opposite to the sweeping brush 150 for receiving the dust and trash swept therein. Moreover, on the upper housing 110, a transparent plate 113 is mounted at a position above the box cover 163, so that, as cooperating with a transparent box cover 163, the user can clearly notice that if the box body 162 is full of trash.

Please refer to FIG. 3, a rear rack 122 is mounted at the rear end of the carrying base 120 through plural pivoting elements 123, and a cleaning cloth set 170 is pivotally mounted on the rear rack 122 to contact with the floor, and can be controlled by a second motor transmission set 143 so as to have a pivot turn. The cleaning cloth set 170 includes an axle 171, which is pivoted to the rear rack 122, and plural cleaning cloth 172 fixedly clipped by the axle 171 and located on the outer surface of the axle 171, and the plural cleaning cloth 172 can be controlled by the second motor transmission set 143 to have a pivot turn, so as to wipe and wax the floor. Besides, the axle 171 of the cleaning cloth set 170 is connected to the second motor transmission set 143 through one end thereof, and the other end is removably pivoted on the rear rack 122 at the rear end of the carrying base 120 through an engaging device 124, so that the user can remove the cleaning cloth set 170 by himself or herself for washing or for exchanging for more suitable ones according to different demands.

Furthermore, between the carrying base 120 and the rear rack 122, an adjusting connecting link 125 is respectively mounted at the two ends thereof, so that through adjusting the length of the connecting link 125, the distance from the rear rack 122 to the floor and the height of the cleaning cloth set 170 from the floor can be adjusted, and thus, the force of the cleaning cloth 172 wiping or waxing the floor as rotating also can be adjusted.

At the front end of the carrying base 120, a universal wheel 180 is mounted thereunder. The universal wheel 180 is controlled by a steering motor set 144 to rotate, so as to drive the sweep and wipe machine 100 to change direction, thereby achieving a right or left turn of the sweep and wipe machine 100.

The electronic control device 190 is electrically connected with the battery 130, the motor change gear set 141, the first motor transmission set 142, the second motor transmission set 143, the steering motor set 144 and the remote control receiver 131. And, a remote controller 200 is used to wirelessly transmit a direction control signal to the remote control receiver 131 for controlling the moving direction of the sweep and wipe machine 100.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A remote controlled sweep and wipe machine, comprising:
an upper housing and a carrying base which are removably assembled together to form an inner space;
a battery, mounted in the inner space;
a remote control receiver, mounted in the inner space;
two tires, mounted at two sides of a rear end of the carrying base to contact with the floor and controlled by a motor change gear set to turn;
a sweeping brush, mounted in the inner space under a sweeping brush cover to contact with the floor and controlled by a first motor transmission set to have a pivot turn;
a dust collecting box, removably located in the inner space, adjacent to the sweeping brush and having a dust collecting opening at a surface opposite to the sweeping brush or receiving the dust swept by the sweeping brush;
a rear rack, mounted at the rear end of the carrying base through plural pivoting elements, and having a cleaning cloth set pivotally mounted thereon to contact with the floor, wherein the cleaning cloth set is controlled by a second motor transmission set so as to have a pivot turn;
a universal wheel, mounted under the carrying base at a front end thereof, and controlled by a steering motor set to rotate;
an electronic control device, electrically connected with the battery, the motor change gear set, the first motor transmission set, the second motor transmission set, the steering motor set and the remote control receiver; and
a remote controller, for wirelessly transmitting a direction control signal to the remote control receiver, so as to control the moving direction of the sweep and wipe machine.

2. The remote controlled sweep and wipe machine as claimed in claim 1, wherein two side brushes are respectively mounted at the two ends of the sweeping brush for gathering the dust toward the sweeping brush.

3. The remote controlled sweep and wipe machine as claimed in claim 1, wherein the sweeping brush comprises a brush main body and plural brush hairs mounted on the brush main body, wherein the brush main body is driven by the first motor transmission set to have a pivot turn so as to clean the floor through the brush hairs.

4. The remote controlled sweep and wipe machine as claimed in claim 1, wherein the brush main body is connected to the first motor transmission set through one end thereof and the other end is removably pivoted to the carrying base through an engaging device.

5. The remote controlled sweep and wipe machine as claimed in claim 1, wherein the cleaning cloth set comprises an axle, which is pivoted to the rear rack, and plural cleaning cloth fixedly clipped by the axle and located on the outer surface of the axle, and the plural cleaning cloth is controlled by the second motor transmission set to have a pivot turn, so as to wipe the floor.

6. The remote controlled sweep and wipe machine as claimed in claim 5, wherein the axle is connected to the second motor transmission set through one end thereof and the other end is removably pivoted to the rear rack at the rear end of the carrying base through an engaging device.

7. The remote controlled sweep and wipe machine as claimed in claim 1, wherein an adjusting connecting link is respectively mounted between the carrying base and the rear rack at two ends thereof, so that through adjusting the length of the connecting link, the force of the rack pressing to the floor is adjusted, and thus, a height of the cleaning cloth set from the floor is also adjusted.

8. The remote controlled sweep and wipe machine as claimed in claim 1, further comprising an external power source plugging hole for connecting to the electronic control device so as to charge the battery.

9. The remote controlled sweep and wipe machine as claimed in claim 1, wherein the dust collecting box is assembled by a box body and a box cover.

10. The remote controlled sweep and wipe machine as claimed in claim 1, wherein the upper housing comprises a power button electrically connected with the electronic control device.
